(19) United States
(12) Patent Application Publication
(10) Pub. No.: US 2012/0271988 A1
(43) Pub. Date: Oct. 25, 2012

(54) METHODS CIRCUITS DATA-STRUCTURES DEVICES AND SYSTEM FOR OPERATING A NON-VOLATILE MEMORY DEVICE

(75) Inventor: Yoav Yogev, Mazkeret-Batya (IL)

(73) Assignee: INFINITE MEMORY LTD., Rosh Ha'ayin (IL)

(21) Appl. No.: 13/497,536

(22) PCT Filed: Oct. 3, 2010
(86) PCT No.: PCT/IL10/00801

§ 371 Date: Jun. 3, 2012

Related U.S. Application Data
(60) Provisional application No. 61/245,167, filed on Sep. 23, 2009.

(51) Int. Cl. G06F 12/00

(52) U.S. Cl. 711/103; 711/E12.008

(57) ABSTRACT

Disclosed are methods, data-structures, circuits, devices and system for operating a non-volatile memory device. According to some embodiments, a controller may operate on different portions (e.g. clusters) of a NVM memory array differently, depending upon a designation of a given portion within a table stored on the array. Portions of the array may be operated in OTP page write mode, while other portions of the array may be operated in either bit level or byte level append modes.

### FIELD OF THE INVENTION

The present invention relates generally to the field of semiconductor based non-volatile memory storage. More specifically, the present invention relates to methods, data-structures, circuits, devices and system for operating a non-volatile memory device.

### BACKGROUND

Non-volatile memory (“NVM”) devices are fabricated in a large variety of structures, including but not limited to polysilicon floating gate, Nitride Read Only Memory (“NROM”), SONOS, etc. For purposes of producing mass data storage devices (e.g. Flash Memory Cards/Sticks, Multimedia Card, etc.), NVM cells are usually organized into and fabricated as part of a large matrix of cells referred to as an array. Depending upon which one of the many known array architectures and operating methodologies is used, each cell in an array may be addressable, programmable, readable and/or erasable either individually or as part of a group/block of cells. Most cell array architectures, including virtual ground arrays, which are well known in the field, include the feature of a multiplicity of repeating segments formed into rows and columns.

As is well known, an NVM cell's logical state may be defined and determined by its threshold voltage (“Vt”), the gate to source/drain voltage at which the cell begins to significantly conduct current. Each cell or charge storage region of a multi-charge storage region NVM device may be associated with a difference threshold voltage and thus may store a unique logical value. Each cell or each charge storage region may be operated (i.e. programmed, erased or read) from a separate terminal or set of terminals of its respective device. The operation of multi-charge storage region NVM devices is well known in the art. The preceding and proceeding discussion relating to the operation of an NVM cell may apply either to the operation of a single charge storage region of a single charge storage region device or to the operation of each charge storage region of a multi-charge storage region device.

For each NVM cell, different threshold voltage values are associated with different logical states, and an NVM cell's threshold voltage level may be a function of the amount of charge (e.g. electrons or holes) stored in the charge storage region of the cell. An array controller integral or otherwise associated with the NVM array may program, erase and read data to and from physical addresses, blocks, segments and clusters of the array. The NVM controller may receive commands and provide data to a device/system controller integral or otherwise associated with array.

Many NVM mass storage devices, such as Flash Memory devices, use data storage tracking, management and retrieval techniques compliant with the “FAT” standard architecture. File Allocation Table (FAT) is a computer file system architecture now widely used on many computer systems and most memory cards, such as those used with digital cameras. FAT file systems are commonly found on floppy disks, flash memory cards, digital cameras, and many other portable devices because of their relative simplicity. The FAT file system is relatively straightforward technically and is supported by virtually all existing operating systems for personal computers. This makes it a useful format for solid-state memory cards and a convenient way to share data between operating systems.

The FAT file system was developed by Bill Gates and Marc McDonald during 1976-1977. It was the primary file system for various operating systems including DR-DOS, FreeDOS, MS-DOS, OS/2 (v1.1) and Microsoft Windows (up until, and including Windows Me).

The FAT file system was created for managing disks in Microsoft Standalone Disk BASIC. In August 1980 Tim Paterson incorporated FAT into his 86-DOS operating system for the S-100 8086 CPU boards; the file system was the main difference between 86-DOS and its predecessor, CP/M.

The name originates from the usage of a table which centralizes the information about which areas belong to files, are free or possibly unusable, and where each file is stored on the disk. To limit the size of the table, disk space is allocated to files in contiguous groups of hardware sectors called clusters. As disk drives have evolved, the maximum number of clusters has dramatically increased, and so the number of bits used to identify each cluster has grown. The successive major versions of the FAT format are named after the number of table element bits: 12, 16, and 32. The FAT standard has also been expanded in other ways while preserving backward compatibility with existing software.

NVM devices usually store and update an internal FAT table on their NVM arrays. Usually, the FAT and a root directory are stored in a portion of the NVM array (e.g. maintenance data portion) not accessible to a device user. Conventional FAT and Root Directory update techniques are not possible when the NVM device is a One Time Programmable (“OTP”) NVM device. Therefore, there is a need in the field of NVM devices for improved methods, data-structures, circuits and systems for data storage-tracking, management and retrieval.

### SUMMARY OF THE INVENTION

According to embodiments of the present invention, there may be provided a non-volatile memory (“NVM”) device including a non-volatile memory array with a set of array portions (e.g. clusters) and a controller adapted to operate on a given portion of said array according to either One Time Programming (“OTP”) mode or Append Mode, depending upon a designation associated with the given array portion. The controller may be adapted to operate portions of said array designated as storing data from a File Allocation Table (“FAT”) in bit-level append mode. The controller may be further adapted to leave a last FAT record from a string of FAT records unwritten (“00”), and wherein the string is associated with a given directory entry in a Directory folder data structure. The controller, or another circuit functionally associated with the controller, may be adapted to output an End-of-File “FF” upon identifying or reading an unwritten record in a string of FAT records. According to further embodiments the controller may be further adapted to append to the last unwritten FAT record a pointer to a next FAT record associated with the given Directory entry, for example a pointer to a next FAT record (when stored data associated with the given Directory entry extends and/or expands into another NVM array portion). The given Directory entry may be associated with a Directory folder data structure stored on the NVM array.

According to further embodiments, the controller may be further adapted to append a record to a folder tracking table (“FTT”) which designates which NVM array portions store data associated with a Directory folder data structure. The controller may be further adapted to operate in byte level append mode for an array portion designated as storing data associated with a Directory folder data structure. The controller may be further adapted to perform a byte level append of a directory entry to an array portion designated as storing data associated with a Directory folder data structure. The controller may be further adapted to update the FTT to include a record of an NVM array portion to which data associated with a Directory folder data structure is extended and/or expanded.

The controller may be adapted to operate in bit-level append mode on portions of the array designated as storing data from a File Allocation Table (“FAT”). The controller may be further adapted to leave a last FAT record from a string of FAT records unwritten (“00”), and wherein the string is associated with a given directory entry in a Directory folder data structure. The controller may be further adapted to append to the last unwritten FAT record a pointer to a next FAT record associated with the given Directory entry. The given Directory entry may be associated with a Directory folder data structure stored on said NVM array. The controller may be further adapted to append to the last unwritten FAT record a pointer to a next FAT record when the Directory folder data structure associated with the given Directory entry expands into another NVM array portion. The controller may further be adapted to append a record to the FTT when the Directory folder data structure associated with the given Directory entry extends into another NVM array portion.

The controller may be adapted to return a write protect error if either page, bit level or byte level append is attempted to NVM array bits which have already been written to.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a functional block diagram of an NVM device according to some embodiments of the present invention, including a HOST interface, a Device/System Controller, an NVM array controller and an NVM array on which a Folder Tracking Table is stored;

FIG. 2A shows a symbolic block diagram of a controller according to embodiments of the present invention along with relationships between data elements within a set of data structures (e.g. Directory folder data structure, FAT and FTT) of an NVM array according to some embodiments of the present invention;

FIG. 2B shows a symbolic block diagram of a controller according to embodiments of the present invention appending data within a set of data structures (e.g. Directory folder data structure, FAT and FTT) of an NVM array according to some embodiments of the present invention;

FIG. 3A shows a flowchart including the steps of a method by which a HOST may add a file or directory folder to ROOT or to another folder on an NVM device according to some embodiments of the present invention; and

FIGS. 3B through 3D show flowcharts, each of which includes steps of a method by which a controller according to embodiments of the present invention may respond to each of three separate instructions (e.g. sector with command and data) from a HOST.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

Furthermore, any of the memory management and/or control methods, techniques, algorithms, elements and/or components; or any of their sub-components or combinations—may be applicable to any type of memory including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system.

The present invention includes methods, circuits, data-structures, devices and systems for storing data on a non-volatile memory array. According to some embodiments of the present invention, the non-volatile memory array may be integral or otherwise associated with a Device/System controller and/or an NVM array controller, both or either of which may be adapted to operate (i.e. write to or read) at least a portion of the array (e.g. array Clusters) in indelible mode, which indelible mode may also be referred to as One Time Program (“OTP”) mode. The terms Controller or controller, as used in the present application, may refer to the operation of an NVM Device/System controller, an NVM array controller or a combination of the two—as may occur in cases where a Device/System controller and an array controller are integrated. According to further embodiments of the present invention, the controller may be further adapted to operate portions (e.g. Clusters, Sectors, etc.) of the NVM array used for operational overhead data, such as File Allocation Table Entries/Records, Folder Directory Entries/Records, and Folder Tracking Tables Entries/Records, in bit or byte level append mode. Such bit or byte level append mode operation may facilitate the programming of non-programmed bits or bytes on the array without allowing for the reprogramming or erasing of programmed bits or bytes. According to further embodiments of the present invention, the controller may be further adapted to operate clusters/portions/sectors of the NVM array identified or designated as being associated with a Directory folder data structure in byte level (e.g. 32 bytes) append mode—facilitating the addition of folder records including: (1) file or folder names, (2) file or folder attributes and (3) FAT table record pointers (i.e. pointers to FAT records).

According to yet further embodiments of the present invention, there may be provided a Folder Tracking Table (“FTT”) which tracking table may include one or more records identifying which clusters/portions/sectors of the NVM array are associated with (e.g. containing data of) a logical Directory folder data structure. The FTT may be updated (e.g. new record added) when a new Directory folder data structure is instanced or created, or when an existing Directory folder data structure is extended/expanded into a new cluster/portion/sector. The FTT may be accessed and/or referenced by the controller, or by a functionally associated logic circuit, when determining which clusters/portions/sectors of the NVM array may be operated in byte level append mode.

According to some embodiments of the present invention, a ROOT Directory (“ROOT”) may be instanced and maintained at some clusters/portion/area of the NVM array. Each time a new file is written to the NVM array, a host controller or application (“HOST”), in coordination with the controller, may append a record (e.g. including file name, file attribute and FAT record pointer to first FAT record) associated with the file to the ROOT. Each time a new directory (i.e. sub-directory of ROOT) is written to the NVM array, the host may append a record to ROOT including: (1) directory name, (2) an attribute indicating the entry is for a directory, and (3) a FAT record pointer to the first FAT record associated with the directory. According to further embodiments of the present invention, when a record associated with a new directory folder is added either to the ROOT or to a directory folder within ROOT, the FTT may be updated (e.g. by the controller) with a record indicating which clusters/portions/sectors of the NVM array include data associated with the newly added directory. Additionally, when a record is added to any directory folder which requires the expansion of the directory folder to be extended or expanded into an additional cluster, a record indicating the new cluster may be added to the FTT.

According to embodiments, there may be provided a non-volatile memory (“NVM”) device including a non-volatile memory array with a set of array portions, and a controller adapted to operate on a given portion of said array according to either One Time Programming (“OTP”) mode or Append Mode, depending upon a designation associated with the given array portion. The NVM array controller may be adapted to operate portions of the array designated as storing data from a File Allocation Table (“FAT”) in bit-level append mode. A controller operating in FAT Append Mode may be adapted to leave a last FAT record from a string of related FAT records unwritten (“00”), wherein the string of related FAT entries may be associated with a given directory entry/record in a Directory folder data structure. The controller, or another circuit functionally associated with the NVM array controller, may be adapted to output an End-of-File “FF” upon reading/identifying an unwritten record in a strong of related FAT records.

According to further embodiments, the controller may be further adapted to append to a last unwritten FAT record (of a group of records associated with a given Directory folder) a pointer to a next FAT record which is/was newly associated with the given Directory folder. The controller may be adapted to append to the last unwritten FAT record a pointer to a next FAT record when stored data within the given Directory entry expands/extends into another (newly added) NVM array cluster/portion/sector. According to some embodiments, the given Directory entry may be associated with a Directory folder data structure stored on the NVM array. The controller may be further adapted to append a record to a folder tracking table (“FTT”) which designates which NVM array Clusters/Portions store data of a Directory folder data structure.

According to some embodiments, the controller may be further adapted to operate in byte level append mode for an array portion (e.g. Clusters or Sectors) designated as storing data associated with a Directory folder data structure. The controller may be further adapted to perform a byte level append of a directory entry to an array portion designated as storing data associated with a Directory folder data structure. Portions of the NVM array storing data associated with a Directory folder data structure may be designated in a record of a Folder Tracking Table (“FTT”). The NVM array controller may be further adapted to update the FTT to include a record indicating a number or address of a newly added NVM array portion or Cluster to which data associated with a Directory folder data structure is extended (e.g. when entries/records are added to the Directory folder data structure).

According to some embodiments, the controller may be adapted to return a write protect error if either bit level or byte level appending is attempted on NVM array bits which have already been written to.

According to some embodiments of the present invention, the need for a logical to physical address mapping table may be obviated. According to some embodiments of the present invention, there may be provided an NVM device without a logical memory address to physical memory address mapping table. According to some embodiments of the present invention, the need for a bad cluster/block/segment/sector table may be obviated. According to further embodiments of the present invention, there may be provided an NVM device without a bad cluster/block/segment/sector table.

According to further embodiments of the present invention, the controller may also be adapted to utilize a mapping data structure (e.g. table) which associates a logical cluster/block/sector/segment address with a physical location on the NVM when accessing (i.e. reading or writing) the NVM array. According to some embodiments, the mapping data structure may be compiled during fabrication, sorting and/or first operation of the NVM. The mapping data structure may be compiled such that bad clusters/blocks/sectors/segments on the NVM array are bypassed and/or avoided (e.g. invisible to the HOST). The mapping data structure may also be compiled such that during operation the NVM array controller shows/presents/returns to a HOST a contiguous set of physical memory addresses which the external controller may reference when accessing (i.e. reading or performing permissible write operations) the NVM array. According to further embodiments of the present invention, each of at least some of the set of physical memory addresses provided by the NVM controller may correspond with an entry in the FAT table. According to yet further embodiments of the present invention, there may be a linear relationship between entries in the FAT table and physical addresses provided by the controller. For example, a first entry in the FAT table may correspond to (i.e. point to) a first memory or cluster address, and each subsequent entry in the FAT table may correspond with a physical memory or cluster address whose offset from the first address is equivalent to the subsequent FAT entries offset from the first FAT entry. Accordingly, a HOST or controller may determine an address of the memory array to access by performing a offset calculation—for example based on the FAT entry number corresponding to the file of interest and the memory address to which the first FAT entry points.

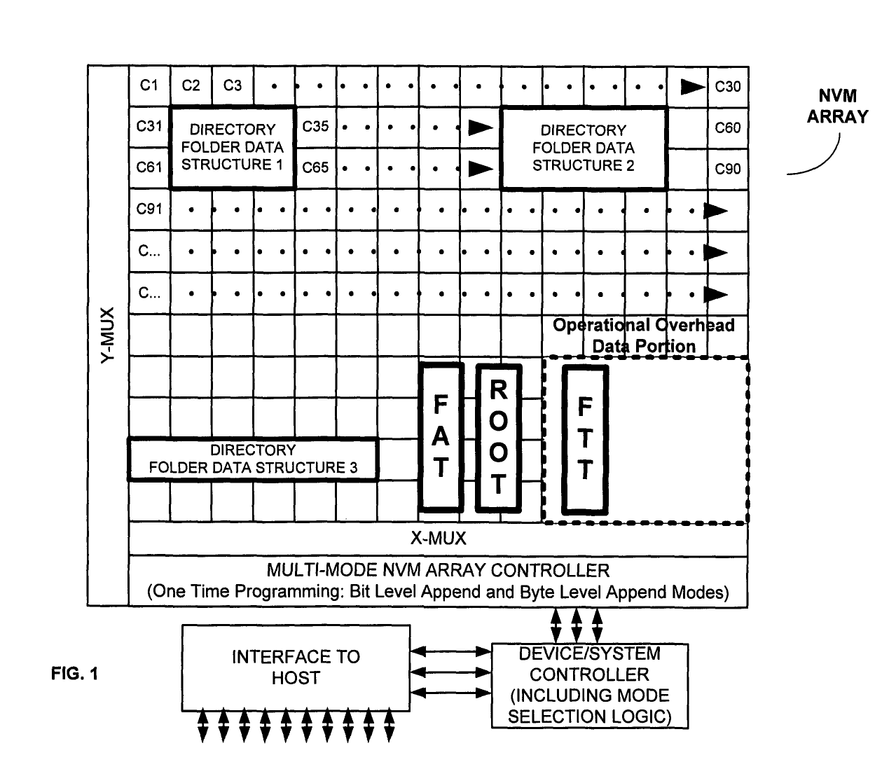

Turning now to FIG. 1, there is shown a functional block diagram of an NVM device according to some embodiments of the present invention, including a HOST interface, a Device/System Controller, an NVM array controller and an NVM array on which a Folder Tracking Table is stored. The controllers may operate clusters of the NVM array in either page OTP mode or in bit level append or byte level append modes, depending on the cluster's designation. A folder tracking table FTT designates which clusters are associated with a Directory folder data structure and should thus be operated in byte level append mode.

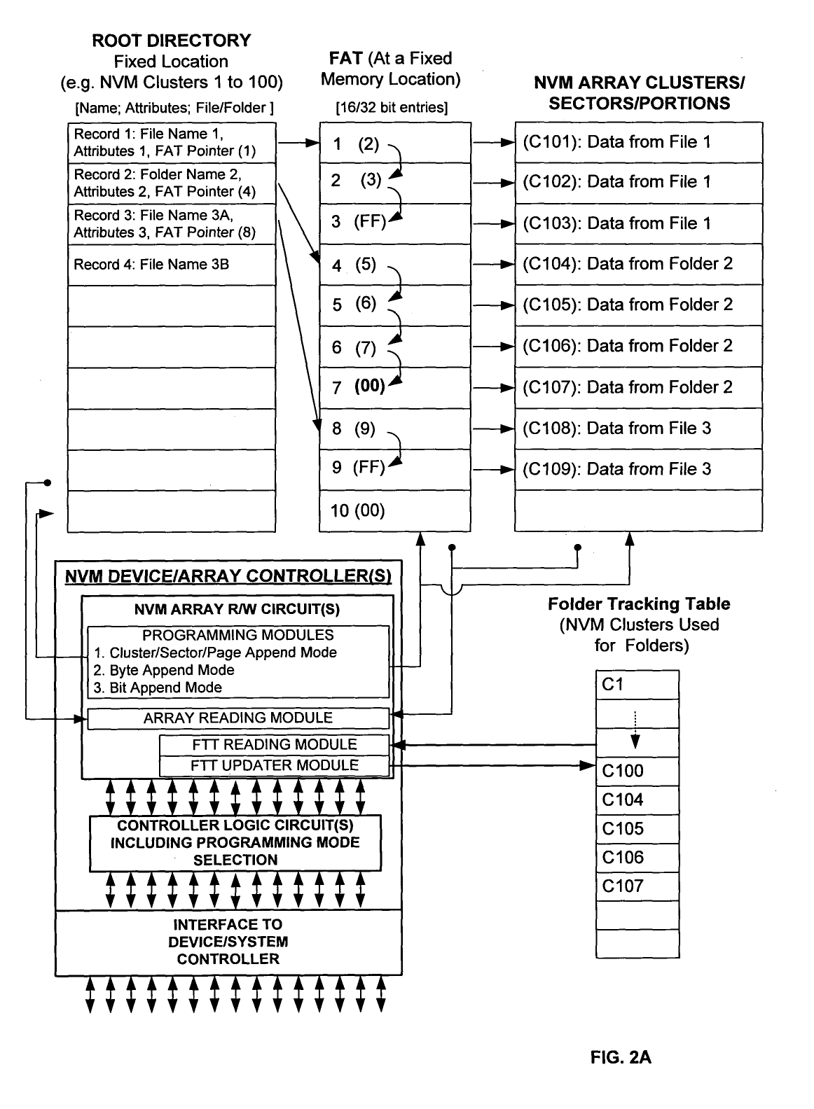

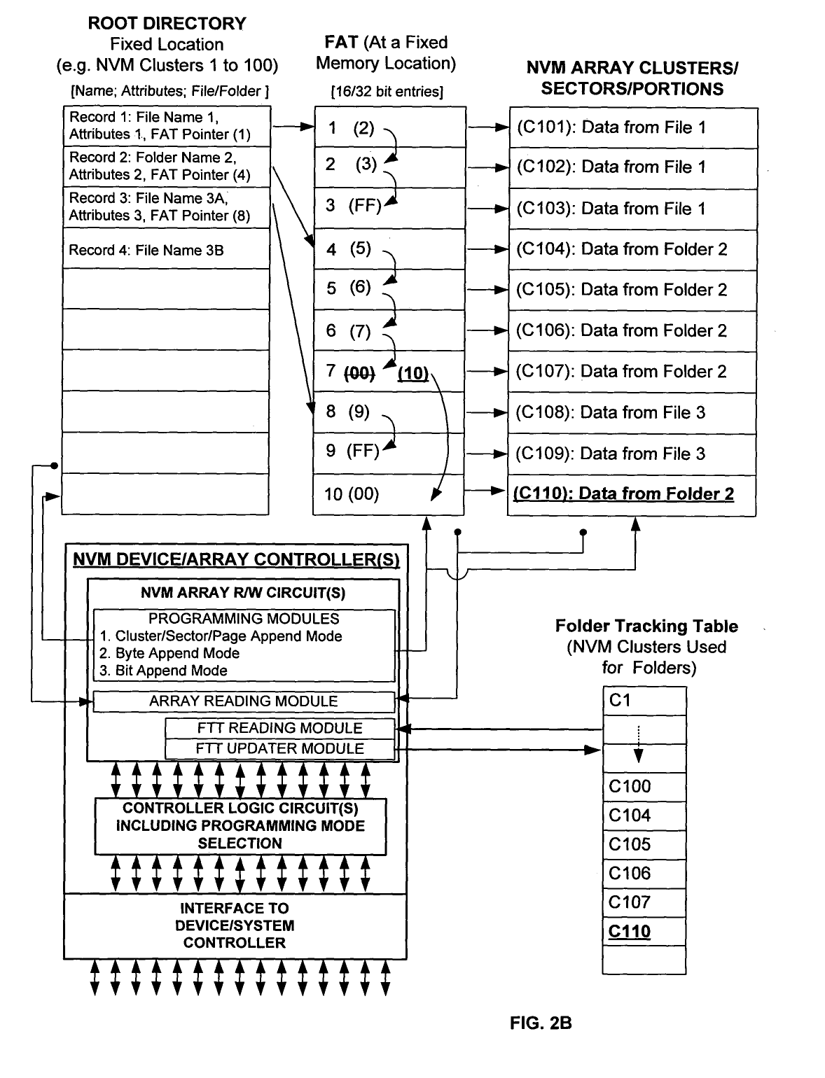

Turning now to FIG. 2A, there is shown a symbolic block diagram of a controller according to embodiments of the present invention along with relationships between data elements within a set of data structures (e.g. Directory folder data structure, FAT and FTT) of an NVM array according to some embodiments of the present invention. Directory entries associated with a folder point to the first of a FAT entry string which ends with a 00 instead of a FF. Also, clusters associated with Directory folder data structured are indicated in a FTT.

Turning now to FIG. 2B, there is shown a symbolic block diagram of a controller according to embodiments of the present invention appending data within a set of data structures (e.g. Directory folder data structure, FAT and FTT) of an NVM array according to some embodiments of the present invention. When the data in the Directory folder data structure of folder name 2 expands to an additional cluster, the last FAT entry associated with data structure is appended to point to a next FAT entry associated with the added cluster. Additionally, the new added cluster number/address is added to the FTT.

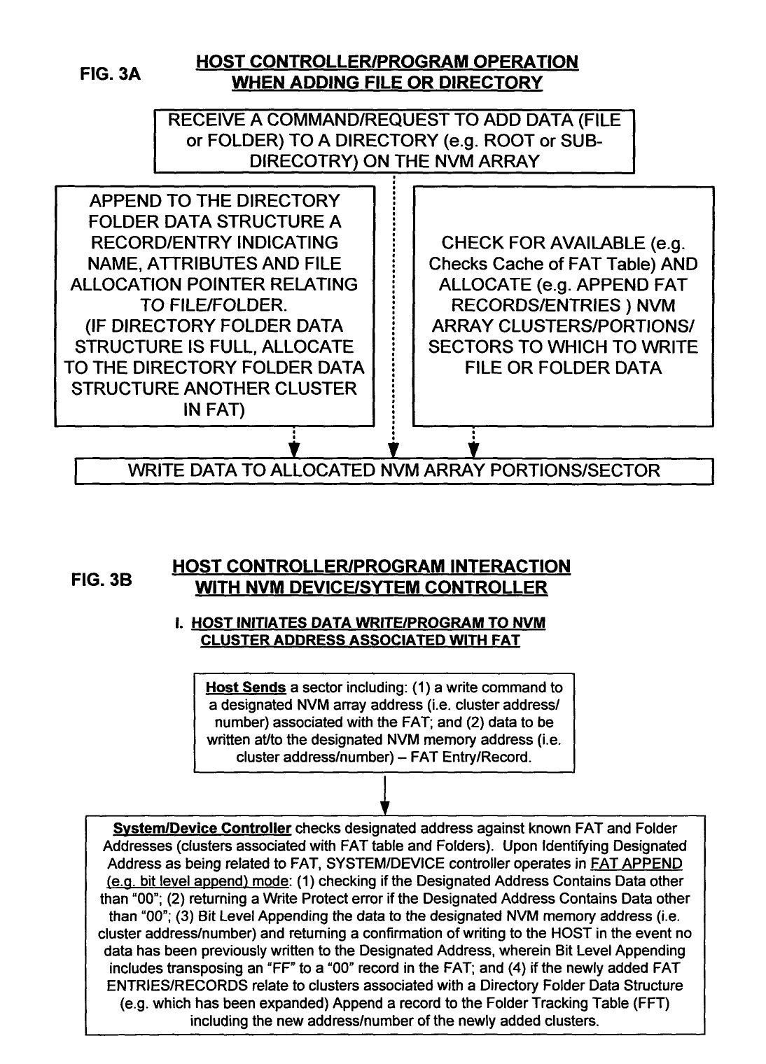

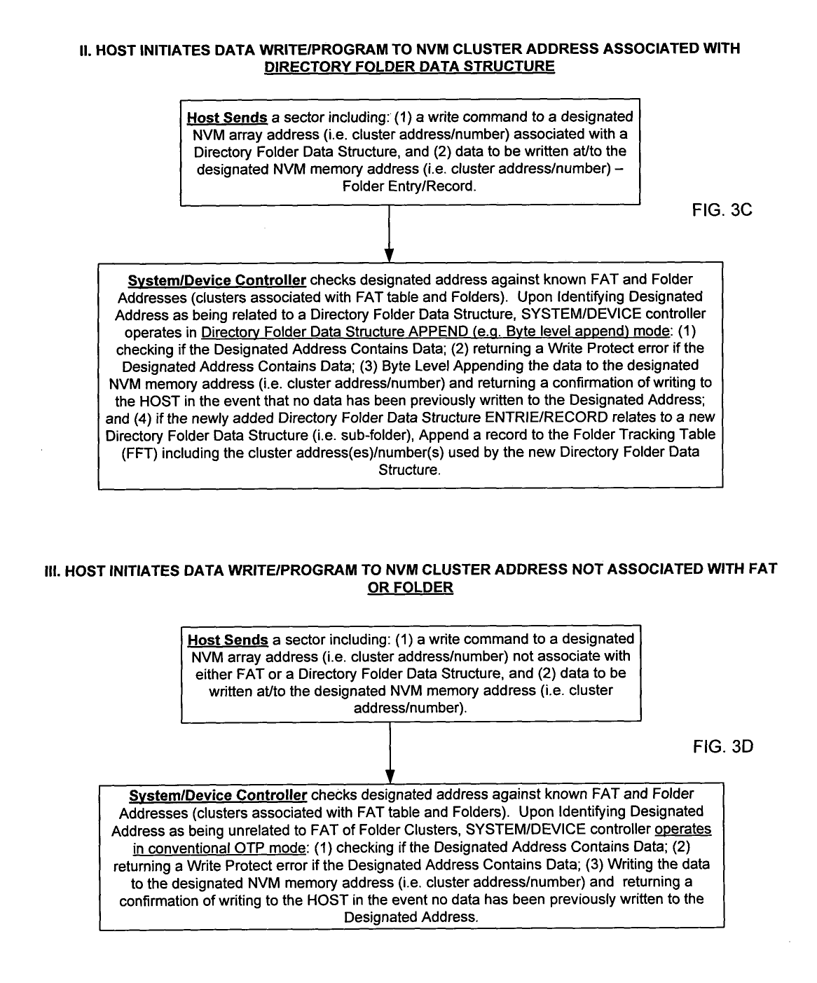

Turning now to FIG. 3A, there is shown a flowchart including the steps of a method by which a HOST may add a file or directory folder to ROOT or to another folder on an NVM device according to some embodiments of the present invention. Each time a file or folder is written to an NVM device, the relevant Directory folder data structure and associated FAT entries are appended by the HOST through the NVM device controller(s). FIGS. 3B through 3D show flowcharts, each of which includes steps of a method by which a controller according to embodiments of the present invention may respond to each of three separate instructions (e.g. sector with command and data) from a HOST. Host may Load the NVM device's master boot record (MBR—Master Boot Record=size of disk, location of FAT) and FAT into cache upon initialization of NVM device with Host. The Host may read data from the NVM Device using conventional methods/protocols and the NVM device/system controller may operate substantially conventionally when Host is reading data—with the exception that “00” FAT entries/records at the end of a FAT record chain associated with a given folder are presented as “FF” to the Host. The Host may write data (files and folders) to the NVM device using conventional methods/protocols, and the NVM device/system controller may operate as follows:

FIG. 3B—Host Initiates Data Write/Program to NVM Cluster Address Associated with Fat

Host Sends a sector including: (1) a write command to a designated NVM array address (i.e. cluster address/number) associated with the FAT; and (2) data to be written at/to the designated NVM memory address (i.e. cluster address/number)—FAT Entry/Record.

System/Device Controller checks designated address against known FAT and Folder Addresses (clusters associated with FAT table and Folders). Upon Identifying Designated Address as being related to FAT, SYSTEM/DEVICE controller operates in FAT APPEND (e.g. bit level append) mode: (1) checking if the Designated Address Contains Data other than “00”; (2) returning a Write Protect error if the Designated Address Contains Data other than “00”; (3) Bit Level Appending the data to the designated NVM memory address (i.e. cluster address/number) and returning a confirmation of writing to the HOST in the event no data has been previously written to the Designated Address, wherein Bit Level Appending includes transposing an “FF” to a “00” record in the FAT; and (4) if the newly added FAT ENTRIES/RECORDS relate to clusters associated with a Directory Folder Data Structure (e.g. which has been expanded) Append a record to the Folder Tracking Table (FFT) including the new address/number of the newly added clusters.

FIG. 3C—Host Initiates Data Write/Program to NVM Cluster Address Associated with Directory Folder Data Structure

Host Sends a sector including: (1) a write command to a designated NVM array address (i.e. cluster address/number) associated with a Directory Folder Data Structure, and (2) data to be written at/to the designated NVM memory address (i.e. cluster address/number)—Folder Entry/Record.

System/Device Controller checks designated address against known FAT and Folder Addresses (clusters associated with FAT table and Folders). Upon Identifying Designated Address as being related to a Directory Folder Data Structure, SYSTEM/DEVICE controller operates in Directory Folder Data Structure APPEND (e.g. Byte level append) mode: (1) checking if the Designated Address Contains Data; (2) returning a Write Protect error if the Designated Address Contains Data; (3) Byte Level Appending the data to the designated NVM memory address (i.e. cluster address/number) and returning a confirmation of writing to the HOST in the event that no data has been previously written to the Designated Address; and (4) if the newly added Directory Folder Data Structure ENTRIE/RECORD relates to a new Directory Folder Data Structure (i.e. sub-folder), Append a record to the Folder Tracking Table (FFT) including the cluster address(es)/number(s) used by the new Directory Folder Data Structure.

FIG. 3D—Host Initiates Data Write/Program to NVM Cluster Address not Associated with Fat or Folder (User Data)

Host Sends a sector including: (1) a write command to a designated NVM array address (i.e. cluster address/number) not associated with either FAT or a Directory Folder Data Structure, and (2) data to be written at/to the designated NVM memory address (i.e. cluster address/number).

System/Device Controller checks designated address against known FAT and Folder Addresses (clusters associated with FAT table and Folders). Upon Identifying Designated Address as being unrelated to FAT of Folder Clusters, SYSTEM/DEVICE controller operates in conventional OTP mode: (1) checking if the Designated Address Contains Data; (2) returning a Write Protect error if the Designated Address Contains Data; (3) Writing the data to the designated NVM memory address (i.e. cluster address/number) and returning a confirmation of writing to the HOST in the event no data has been previously written to the Designated Address.

Since the operation of a HOST using a NVM device according to embodiments of the present invention is substantially conventional, it should be clear to one of skill in the art which permutations of the above the described operational sequences may be required/initiated when a Host Controller attempts to: (1) Add a file or folder to Root, and/or (2) Add a file or folder to a folder within root.

According to some embodiments of the present invention, the need for substantially replicating an OTP type NVM device's FAT each time a Directory Folder Data Structure is extended to a new cluster may be obviated. According to further embodiments of the present invention, OTP type NVM devices may provide a more accurate reading of available data storage space. According to further embodiments of the present invention, the NVM device is a true write once read many implementation and the user is not in danger of losing access to his files as might happened in other standard OTP implementations.

According to some embodiment, all flash operations may be 1's complement operations. As normal erased value in NVM memory is FF, and 00 values are associated with fully program value, and as normal erase value in any File operating system including FAT's (fat12, fat16, fat32 and any other file system) is equal to 00, the present NVM internal micro controller may translate any given value using ones complement known method to mitigate NVM program operations.

Below is an example of a conversion table which may be used:

| | Actual 1's complement |
|---|---|
| host hex value | NVM value |
| 0 | F |
| 1 | E |
| 2 | D |
| 3 | C |
| 4 | B |
| 5 | A |
| 6 | 9 |
| 7 | 8 |
| 8 | 7 |
| 9 | 6 |
| A | 5 |
| B | 4 |
| C | 3 |
| D | 2 |
| E | 1 |
| F | 0 |

### Exemplary Embodiment of NVM Controller Operation

### Exemplary NVM Array's Memory Addresses

MBR—0
LBR—103
FAT1—104-131
FAT2—132-159
Root Folder Clusters—160-191
Data Cluster—192-7049

### Read/Write Command Sequence—Host Address Interpretation

### Private Case Example

System controller gets read or program command from the Host
IF host address (LBA)<104—go to MBR handling
Else if host address (LBA)<160—go to FAT handling
Else if address appears in FTT—go to Folder handling
Else—At this point the data is identified as normal data packet—Normal read or write is executed

### MBR Handling

If write—return WP violation
If read—return fix value from fix data value

### FAT Handling

If Address>131->FAT2 data
   If read return value from FAT1
   if write do nothing
Each sector associated with 2 Memory pages
If write:
   Read the data from OTP.
   Compare that new data consist of additions only
   If not addition only return WP violation
   If the FAT entry is the last entry of folder do not pgm the FF data and pgm the previous entry with the current index instead
   If 16 bits addition then pgm the new data in 1 bit/cell operation
If read: read the sector in 1 bit/cell operation and return

### Folder Handling

If write: check the following:
   The entry is valid addition to folder (n 32 bytes chunks and all changes from 0 to value)
      If Entry is not valid return WP violation.
      Entry is valid: If the new file is folder (check file attributes)
      add the associated clusters to the FTT
      Add entry the matching page.
      Do not write folder name if it equal to “new folder”
If read: normal 1 bit/cell read operation
   In case of Zero name return “New folder”

### Maintaining Folder Tracking Table (FTT)

Maintain pages list (FTT)
   Initial list (Root, 16 pages from management area and all new folder clusters)
   Maintain min of 2 files per MB
   On power-up if Min is not achieved mark free entries in the FAT as F7 (bad cluster) and use the 16 KB data as additional pages to be used for folders.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A non-volatile memory (“NVM”) device comprising:
a non-volatile memory array including a set of array portions; and
a controller adapted to operate on a given portion of said array according to either One Time Programming (“OTP”) mode or Append Mode depending upon a designation associated with the given array portion.

2. The device according to claim 1, wherein said controller is adapted to operate portions of said array designated as storing data from a File Allocation Table (“FAT”) in bit-level append mode.

3. The device according to claim 2, wherein said controller is further adapted to leave a last FAT record from a string of FAT records unwritten (“00”), and wherein the string is associated with a given directory entry in a Directory folder data structure.

4. The device according to claim 3, wherein said controller or another circuit functionally associated with said controller is adapted to output an End-of-File “FF” upon identifying or reading an unwritten record in a strong of FAT records.

5. The device according to claim 3, wherein said controller is further adapted to append to the last unwritten FAT record a pointer to a next FAT record associated with the given Directory entry.

6. The device according to claim 5, wherein said controller is adapted to append to the last unwritten FAT record a pointer to a next FAT record when stored data associated with the given Directory entry extends and/or expands into another NVM array portion.

7. The device according to claim 6, wherein the given Directory entry is associated with a Directory folder data structure stored on said NVM array.

8. The device according to claim 7, wherein said controller is further adapted to append a record to a folder tracking table (“FTT”) which designates which NVM array portions store data associated with a Directory folder data structure.

9. The device according to claim 7, wherein said controller is further adapted to operate in byte level append mode for an array portion designated as storing data associated with a Directory folder data structure.

10. The device according to claim 7, wherein said NVM array controller is further adapted to perform a byte level append of a directory entry to an array portion designated as storing data associated with a Directory folder data structure.

11. The device according to claim 1, wherein said controller is adapted to operate in byte-level append mode portions of said array designated as storing data associated with a Directory folder data structure.

12. The device according to claim 11, wherein portions of said NVM array are designated as storing data associated with a Directory folder data structure in an entry of a Folder Tracking Table (“FTT”).

13. The device according to claim 12, wherein said controller is further adapted to update the FTT to include a record of an NVM array portion to which data associated with a Directory folder data structure is extended and/or expanded.

14. The device according to claim 13, wherein said NVM array controller is adapted to operate in bit-level append mode on portions of said array designated as storing data from a File Allocation Table (“FAT”).

15. The device according to claim 14, wherein said controller is further adapted to leave a last FAT record from a string of FAT records unwritten (“00”), and wherein the string is associated with a given directory entry in a Directory folder data structure.

16. The device according to claim 15, wherein said controller is further adapted to append to the last unwritten FAT record a pointer to a next FAT record associated with the given Directory entry.

17. The device according to claim 16, wherein the given Directory entry is associated with a Directory folder data structure stored on said NVM array.

18. The device according to claim 17, wherein said controller is further adapted to append to the last unwritten FAT record a pointer to a next FAT record when the Directory folder data structure associated with the given Directory entry expands into another NVM array portion.

19. The device according to claim 18, wherein said controller is further adapted to append a record to the FTT when the Directory folder data structure associated with the given Directory entry extends into another NVM array portion.

20. The device according to claim 1, wherein said controller is adapted to return a write protect error if either bit level or byte level append is attempted to NVM bits which have already been written to.
